(19) United States
(12) Patent Application Publication
(10) Pub. No.: US 2008/0028070 A1
(43) Pub. Date: Jan. 31, 2008

(54) METHOD AND SYSTEM FOR REMOTE MANAGEMENT OF ONLINE ACTIVITIES

(76) Inventor: Vikas Gupta, San Francisco, CA (US)

Correspondence Address: PERKINS COIE LLP, P.O. BOX 2168, MENLO PARK, CA, 94026, US

(21) Appl. No.: 11/627,914

(22) Filed: Jan. 26, 2007

Related U.S. Application Data
(60) Provisional application No. 60/833,311, filed on Jul. 27, 2006.

(51) Int. Cl. G06F 15/173

(52) U.S. Cl. 709/224

(57) ABSTRACT

A method and a system for performing online tasks is disclosed. An addressable entity is created for a task. A user sends a task message to this addressable entity. The task message includes task content and sender information. The task content and the sender information are extracted from the task message. The task message is authorized by the owner of the task, or by using a set of pre-defined rules. Once the task message has been authorized, the online task is managed based on the extracted content.

### CROSS-REFERENCE TO RELATED APPLICATIONS

The present application is a utility patent application based on and claiming priority to Gupta's U.S. Provisional Patent Application No. 60/833,311, filed Jul. 27, 2006, the contents of which are incorporated herein by reference.

### FIELD OF THE INVENTION

The invention relates to remote management of online activities. More specifically, the invention relates to easy management of online activities through messages.

### BACKGROUND

The use of Internet has seen an exponential growth over the last few years. A lot of tasks can now be performed from a remote location through the Internet. For example, people can book tickets online, write blogs, share pictures with friends, send greetings, take data backups, maintain calendar schedules, shop online, perform research etc., by logging onto the specific Internet website and following a series of steps to execute the task. While performing a task, people use their email addresses to register on the website. Typically, the email addresses are used to send and receive information of interest. For example, while booking an airline ticket, the user receives a copy of the airline ticket over email.

A user may need to perform multiple tasks through the internet. Oftentimes, the same email address is used by the user to perform all these tasks. This leads to a large number of emails in the email folders and it becomes onerous for the user to find the ones that are related to one another. Users sometimes create folders for emails, and then implement rules to automatically sort emails into these folders. However, these rules work only for desktop-based applications and not for online mail applications. Further, often it is the case that the user has finished the task and is no longer interested in receiving emails from the source website. However, spam and unwanted emails continue to come to the email address.

The existing email providers suffer from one or more of the following limitations, when facilitating the execution of online tasks. Firstly, users need to explicitly create email addresses to receive emails. Further, users cannot simply choose an email address with certain restrictions (For example, restricting the email id to a certain task or time frame etc). They have to explicitly sign up for an account on the email provider's website regardless of the use the email id is created for. Such creation of an email address is a cumbersome process, and therefore, the same email address is commonly used for multiple tasks.

Secondly, current email providers do not provide the facility of automatically creating multiple email addresses for the same user information. Moreover, a user cannot create an email address that is used only for the lifetime of a task.

For activities that do not require an email address, the user needs to log on to an online account and perform a series of steps to execute the task. For example, to publish a blog, a user needs to log-on onto the website of the blog provider (such as www.blogger.com), visit the section that allows the user to enter a new post, type the new post, and then click a button to publish the new entry on the blog. One of the major disadvantages of such existing systems is that if the Internet connection is lost or is timed out at the time of uploading the blog entry, the user has to start the entire process of executing the task all over again.

In light of the drawbacks of the existing art, there exists a need for a system and a method for easy management of online tasks. There also exists a need for a system and a method that allows users to accumulate and manage content related to particular tasks. Further, there is a need for a system and method for providing users with the ability to perform an online task, without worrying about an Internet connection timeout.

### SUMMARY OF THE INVENTION

The present invention contemplates a variety of systems, methods, techniques and mechanisms for remote management of online tasks.

The present invention also teaches systems and methods to extract content from a message, and to execute an online task in accordance with the content of the message.

The present invention teaches a suite of activities contained in messages that a user would normally do manually. Certain embodiments describe means for interacting with an online task or folder using messages. Other embodiments contemplate an easy way to sort messages according to the task they are used for.

Yet another aspect of the invention is to provide users the ability to create a new addressable entity for every task they perform.

Another embodiment of the invention provides users with the ability to create an addressable entity for a task, associate the address with this task, and view all messages, conversations and addressed content along with other content associated with this task. A further aspect of the invention provides users the ability to create short-lived addresses and addressable entities.

According to an embodiment of the invention, a method to manage an online task is disclosed. An addressable entity is created for the online task. A user sends a task message to this addressable entity. The task message includes task content and sender information. The task content and the sender information are extracted from the task message. The online task is managed based on the extracted content. Optionally, the results of the managed task can be sent to a user, or a log of the activity can be created.

According to another embodiment of the invention, the task message is authorized prior to the execution of the online task. This authorization can be automated by subjecting the incoming message to a set of pre-defined rules. Alternatively, an owner of the task can manually authorize the execution of the task received in the task message.

### BRIEF DESCRIPTION OF THE DRAWINGS

The various embodiments of the invention will hereinafter be described in conjunction with the appended drawings provided to illustrate and not to limit the invention, wherein like designations denote like elements, and in which:

FIG. 1 is a schematic representing an exemplary environment for the invention;

FIG. 2 is a schematic representing the system to manage online tasks using messages, in accordance with an embodiment of the invention;

FIG. 3 is a schematic representing a message processor, in accordance with an embodiment of the invention;

FIG. 4 is a schematic representing a task manager in accordance with an embodiment of the invention;

FIG. 5 is a flowchart illustrating a method to manage online tasks using messages, in accordance with an embodiment of the invention; and

FIG. 6A and FIG. 6B are flowcharts representing methods to authorize a task message, in accordance with an embodiment of the invention.

### DETAILED DESCRIPTION

### Definitions:

### Owner—Includes the user who creates an account with the system of the disclosed invention and owns any authorization of the tasks.

Sender—Includes any user who sends a task message to the system of the disclosed invention. A sender may or may not be the owner.
User—Includes any person or entity using the system or method of the disclosed invention. The user may or may not be the owner.

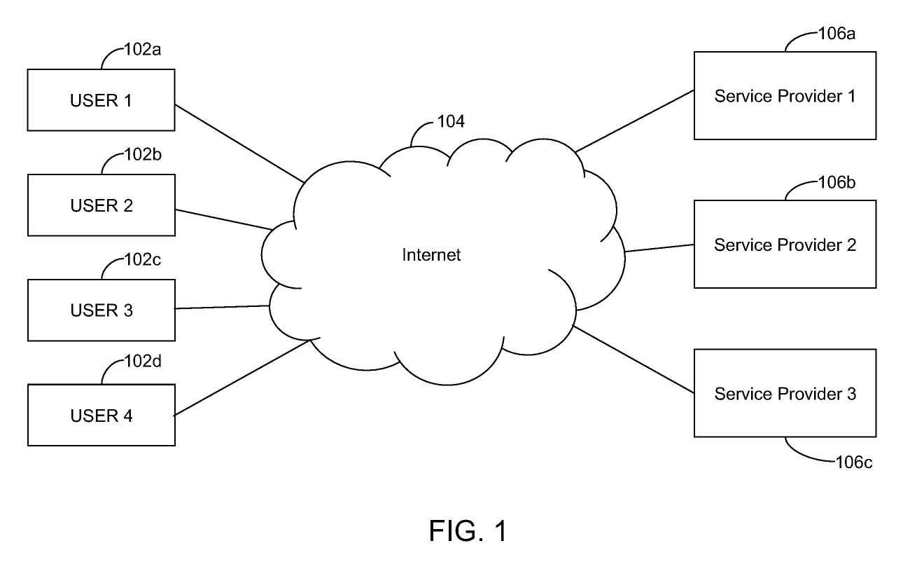

FIG. 1 is a schematic representing an exemplary environment for the invention. Users 102a, 102b, 102c and 102d are connected to Internet 104 through computing devices. The computing devices may be personal computers, mobile handheld devices, personal digital assistants (PDAs), mobile phones and the like. Further, the computing devices include input and output devices for interaction with users 102a, 102b, 102c and 102d. Service providers 106a, 106b, and 106c are also connected to Internet 104. It will be apparent to a person skilled in the art that there may be any number of users and service providers instead of the four users and the three service providers as depicted in FIG. 1.

Users 102a, 102b, 102c and 102d may be connected to the Internet through various media. These media include, but are not limited to, software applications like web browsers, and instant messaging (IM) clients. The software applications may run on various computing devices. The computing devices may be personal computers, mobile handheld devices, personal digital assistants (PDAs), mobile phones and the like.

Service providers 106a, 106b, and 106c provide various online services to users 102a, 102b, 102c and 102d. These services include, but are not limited to, emails, blogs, shopping, information display, remote data storage and the like. Users 102a, 102b, 102c and 102d connect to service providers 106a, 106b, and 106c to use their services. The utilization of these services by the users will hereinafter be referred to as an online task. These tasks include, but are not limited to, publishing blogs, booking tickets, shopping, updating profiles on social networks, planning travel, storing data and the like.

In one embodiment of the invention, users 102a, 102b, 102c and 102d manage these tasks by sending task messages addressed to an addressable entity. Users 102a, 102b, 102c, and 102d are able to interact with the task, wherein messages sent by users 102 result in pre-programmed action to be taken on the task based on the content of the message. Task messages may be emails, Instant Messages, Short Messaging Service (SMS) and Multimedia Messaging Service (MMS) and other forms of messages. These messages may be sent through various computing devices, including, but not limited to personal computers, mobile handheld devices, personal digital assistants (PDAs), mobile phones and the like. Task messages can also be in any form of data stream from one software component to another. It will be apparent to one skilled in the art that the forms of task messages mentioned herein are purely exemplary in nature, and that task messages can be sent in form without deviating from the scope of the invention.

The task message includes sender information and task content. The task message can also optionally include task information. The sender information identifies the user from whom the task message is received. The sender may or may not be the owner of the task. In case the sender is not the owner of the task, the sender may optionally be authorized before the task is executed. The sender information may be in the form of an email address, a phone number, an IM username, an IP address and the like. Task content is content related to the task that needs to be executed. Task content could be text, photographs, multi-media files and the like. It can also be a series of instructions, or programs that can interact with the task.

While some task messages may just post content, others can be programmatically worked on to post more structured data (e.g., appointments, contacts etc.) For example, for a user who wishes to update a blog, task content will be the text of the new blog post. Task information contains instructions on the specific activity that needs to be performed. For example, in case the task is to upload files onto an online database, the task information will carry instructions to upload files. For task information that specifies the task as uploading files, task content will be the files that need to be uploaded. For a user who wishes to book an airline ticket, task content will be specifics of the travel schedule, and other preferences with respect to airlines, time of flight etc. Content in context of the invention refers to any form of data that can be stored on a disk, can be read by a software application and can be communicated from one application to another over a network or on the same computing device.

In accordance with an embodiment of the invention, a user may register with the system provided by the invention, create an account and choose a username. The user may create addressable entities to perform online tasks. The addressable entity is an entity that receives the task message. The addressable entity may be, for example, an email address, an IM username, a phone number and the like. Each addressable entity can be specific to a particular task and a particular user. For example, user 102a will have unique addressable entity to perform the task of blogging.

In accordance with an embodiment of the invention, the addressable entity is an email address and is chosen such that it represents the name of a user and the task it is used to perform. The invention provides for automatic creation of an email address as an extension of the user's existing account. For example the addressable entity may be user102a-blog@jambool.com. The addressable entity also corresponds to a task management workspace for the user. For example, email address user102a-blog@jambool.com will have a workspace allocated for handling messages received on the email address. The workspace may include folders on a server. Messages received on the email address are automatically associated with the task. Content is extracted from the received messages, and stored as part of user's bookmarked content. This content can include URLs, email addresses, postal addresses, documents, images, text, and any other form of content that can be sent in messages using software applications. The content can also include programs, instructions or executable files to perform specific tasks. The content can also be a program that determines the action that needs to be performed on the task. Users can specify rules on the addressable entity as well as the task.

In accordance with another embodiment of the invention, managing an online task includes interacting with the task, or a folder corresponding to the task. The user sends a task message. The task message sent by the user can include a series of instructions, which lead to pre-programmed action being taken on the task. The series of instructions are extracted from the message and the server determines whether the series of instructions need to be executed for the particular task. The server may carry out any form of validation before executing the series of instructions. For example, the server can authorize the sender of the task. Alternatively, the server can request the owner of the task for authorization to execute the specific program that is requested in the task message. Once the task message has been authorized, a log of the activity can be created. The results of the specific activity performed on the task can be posted in the task folder. The results can also be sent to the owner of the task, the sender of the task message or multiple recipients, depending on what is specified in the task message. Alternatively, the recipients can be pre-specified in the task folder itself, and results of all activity on the particular task are sent to these pre-specified recipients.

For example, a user can send a task message to search for information in a specific database. The user sends a task message containing the name of the database to be searched, and at least one search string that should be used for the search. Upon receiving the task message, the system authenticates the sender of the task. In case the sender is not the owner of the task, the system sends a message to the owner of the task, requesting for authorization of the sender. The message also includes a request for authorization to conduct the search on the requested database. Alternatively, the task can have an existing list of authorized users along with the list of databases that they can search. In such a case, the authorization is done by mapping onto a set of predefined rules for the task. Upon authorization, the search is conducted on the requested database, using the specified search string. A log of the activity can be created. The results of the search can be posted on the task folder. Alternatively, the results of the search can be sent back to the user in the form of a message. The results of the search can also be sent to multiple recipients, in case this is specified in the task message.

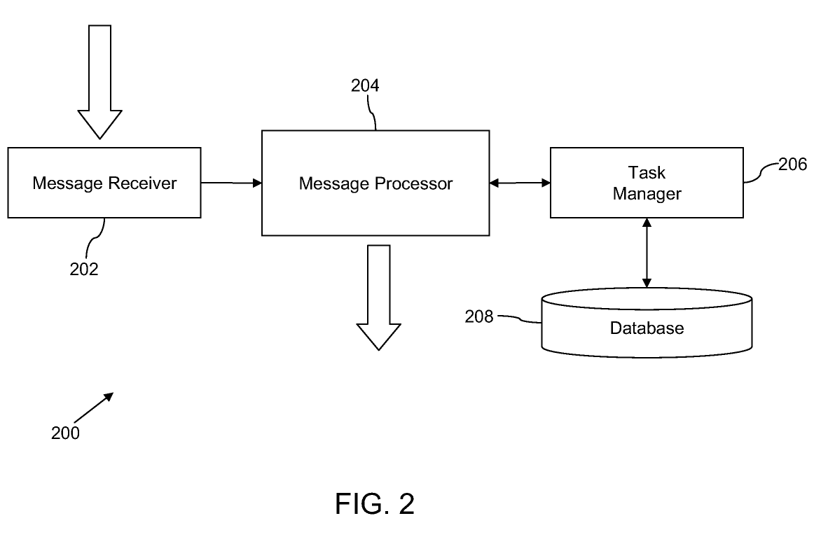

FIG. 2 is a schematic representing a system for performing online tasks using messages, in accordance with an embodiment of the invention. System 200 has a message receiver 202, a message processor 204, a task manager 206, and a database 208.

Message receiver 202 is used for receiving the incoming messages. For example, the incoming message can be in the form of an email, SMS, Instant Message, Phone call, Voice over IP, and data sent over a network connection from a client application. Message receiver 202 ensures that the task message is received correctly and is passed to message processor 204. According to an embodiment of the invention, the messages are received as emails. In this embodiment, message receiver 202 is in the form of a message transfer agent or MTA. Also, the addressable entity is an email address and is chosen such that it comprises the name of the user and the task it is used to perform. For example the addressable entity may be user102a-blog@jambool.com. The MTA receives the task email sent to an account of the form “user-task.” The MTA extracts the username from the email address, and determines if the user is a registered user. The MTA forwards the command to the message processor 204 only for registered users and only if the task email is of the form “user-task.”

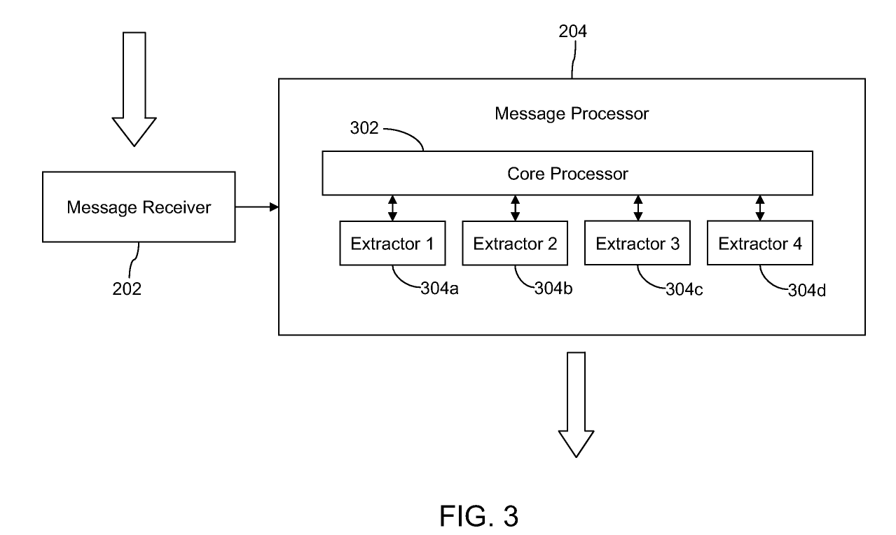

Mail processor 204 receives task message from message receiver 202. Mail processor 204 is capable of extracting the content of the task message. Mail processor 204 sends task message content and authorization and task requests to task manager 206. Mail processor 204 also identifies the sender of the task message and sends out replies and authorization requests to the user and to other external agents. Further details regarding mail processor 204 have been discussed in conjunction with FIG. 3.

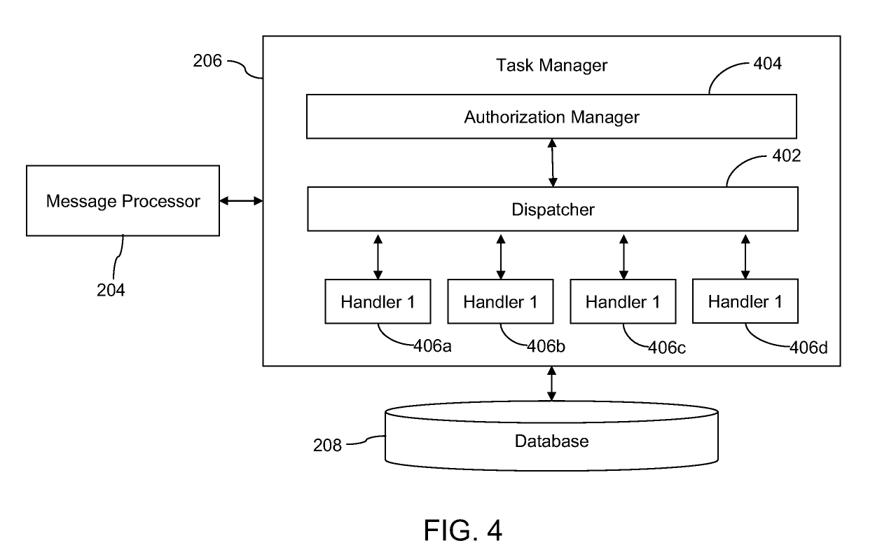

Task manager 206 receives task message content and authorization and task requests from mail processor 204. Task manager 206 is connected to database 208 and is capable of performing read and write operations on database 208. Further details regarding task manager 206 have been discussed in conjunction with FIG. 4.

Database 208 comprises user information, user settings information and task information for all users. User information includes user identification information, user profile information and the like. User settings information includes user preference for authorization, active tasks, passive tasks and the like. Task information comprises the instructions for every task the user performs. For example, task information can be ‘blog’, in case the task message is intended to publish a blog.

FIG. 3 is a schematic representing message processor 204, in accordance with an embodiment of the invention. Message processor 204 further comprises a core processor 302 and extractors 304a, 304b, 304c and 304d. Core processor 302 is connected to extractors 304a, 304b, 304c and 304d. Core processor 302 receives and analyses the task message. Based on the task required to be performed, core processor 302 forwards the task message to one or more of extractors 304a, 304b, 304c and 304d.

Although only four extractors have been illustrated in FIG. 3, it will be apparent to a person skilled in the art that there may be any number of extractors connected to core processor 302. Extractors 304a, 304b, 304c and 304d are each capable of extracting a particular kind of content from the task message. For example, extractor 304a identifies all URLs in a task message and extracts the URLs. In accordance with an embodiment of the invention, extractors 304a, 304b, 304c and 304d populate hash files with the extracted content.

In a particular implementation of the invention, core processor 302 gathers information about extractors 304a, 304b, 304c, and 304d by querying the module's runtime environment. In another implementation, extractors 304a, 304b, 304c, and 304d register themselves with core processor 302 at the startup time of system 200. Extractors 304a, 304b, 304c, and 304d respond to a common behavior or interface that core processor 302 uses to invoke extractors 304a, 304b, 304c, and 304d.

FIG. 4 is a schematic representing task manager 206 in accordance with an embodiment of the invention. Task manager 206 further comprises a dispatcher 402, an authorization manager 404, and handlers 406a, 406b, 406c and 406d. Dispatcher 402 receives all authorization and task requests from message processor 204. Dispatcher 402 analyses the request and handles them by activating authorization manager 404 or handlers 406a, 406b, 406c and 406d. Further dispatcher 402 sends responses back to message processor 204. When dispatcher 402 receives an authorization request, dispatcher 402 identifies the user and the task and forwards the request to authorization manager 404.

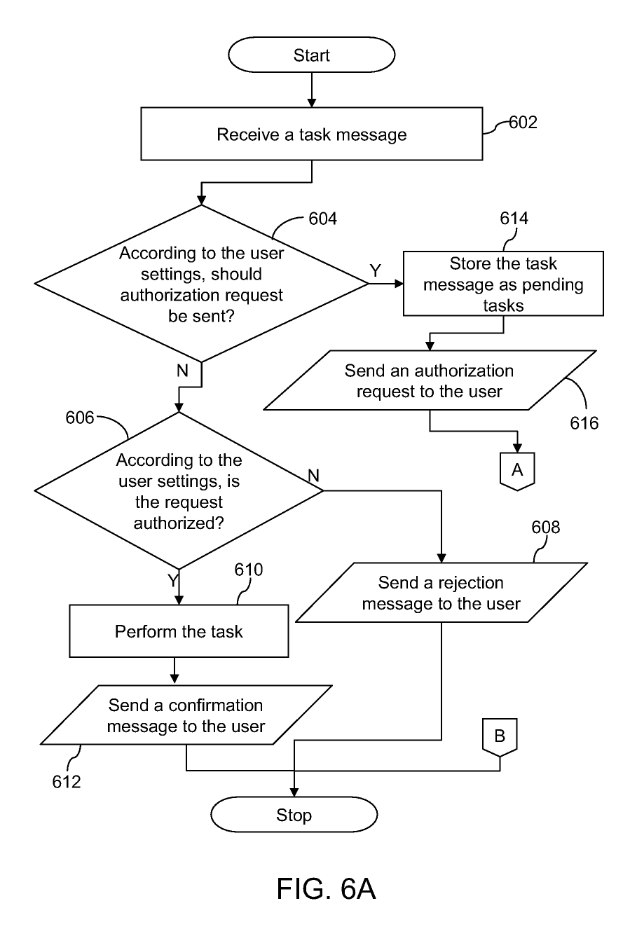

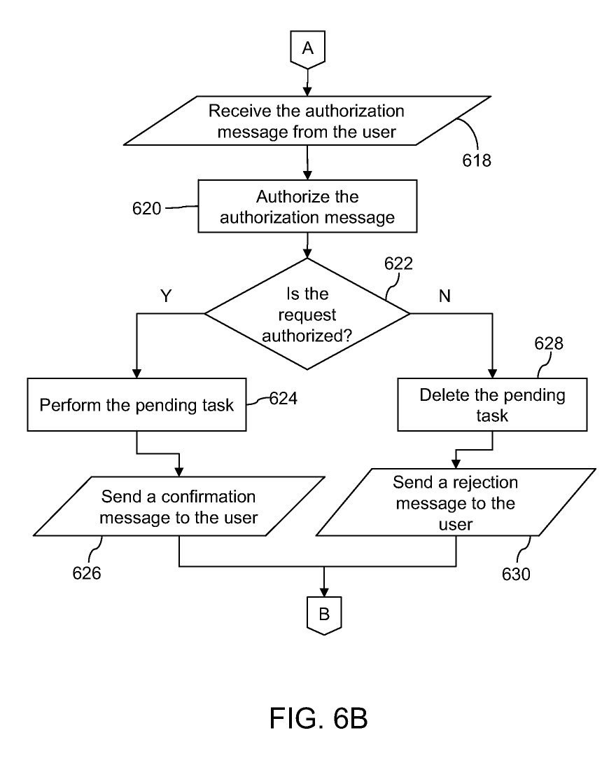

Authorization manager 404 receives authorization request from dispatcher 402. It then retrieves authorization settings from database 208, interprets the authorization settings and accordingly responds to dispatcher 402. It determines whether a task message is authorized or not. Authorization manager 404 also determines if an authorization request is pending for a task message. It also provides the authorization details related to the received task message back to dispatcher 402. Further, authorization manager 404 performs read and write operations on database 208 for authorization pending tasks. Further details regarding the method of authorization of a task have been discussed in conjunction with FIG. 6A and FIG. 6B.

Dispatcher 402 is connected to handlers 406a, 406b, 406c and 406d. Handlers 406a, 406b, 406c and 406d receive content of the task messages and instructions from dispatcher 402. Although only four handlers have been illustrated in FIG. 4, it will be apparent to a person skilled in the art that there may be any number of handlers in task manager 206. According to an embodiment of the invention, the content of the task messages, as received by handlers 406a, 406b, 406c and 406d is in form of content hash files. These content hash files are created by extractors 304a, 304b, 304c and 304d. Handlers 406a, 406b, 406c and 406d perform appropriate read or write operation on database 208 using the task message content. Each of handlers 406a, 406b, 406c and 406d performs read or write operation for a particular kind of content. For example, handler 406 may be a bookmark handler that seeks all the URL content in the hash file, and adds the URL content as bookmarks to the user's task information.

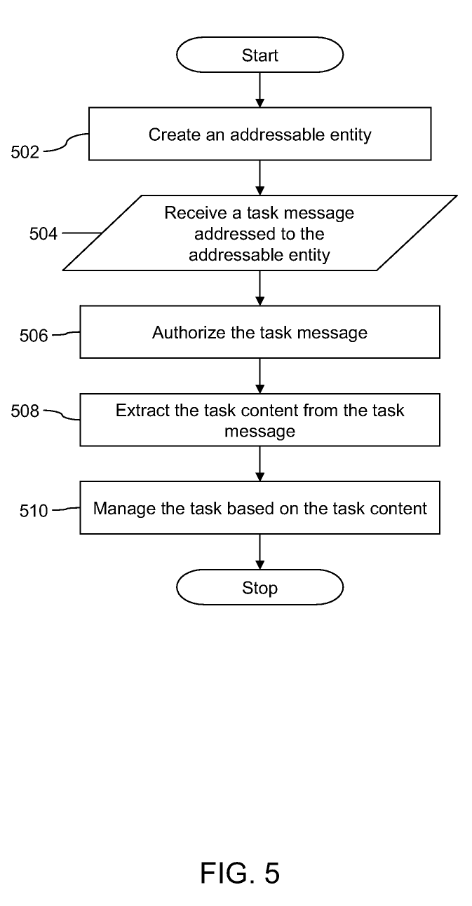

The system as described in conjunction with FIG. 2, FIG. 3, and FIG. 4 executes the method as described in conjunction with FIG. 5, FIG. 6A and FIG. 6B for managing online tasks using messages.

FIG. 5 is a flowchart illustrating the method to perform online tasks using messages, in accordance with an embodiment of the invention. At step 502, an addressable entity is created. According to an embodiment of the invention, the addressable entity may be an email address chosen such that it represents the name of a user and the task it is used to perform. For example the addressable entity may be user102a-blog@jambool.com. The user can create this addressable entity by logging on and changing the user settings. The user may also create an addressable entity by sending a message to the system. If an existing user, who may not be using a particular task, sends a task message addressed to an addressable entity for that task, then a new addressable entity is created for the task. For example, if user 102a does not use blog task service with jambool.com, and sends a task message to user102a-blog@jambool.com, then the addressable entity user102a-blog@jambool.com is automatically created, and may be used by user 102a in the future to perform the task of blogging.

At step 504, the task message sent by the user is received by message receiver 202. Thereafter, at step 506, the task message is authorized. At this step, the username and the task are extracted from the addressable entity and the extracted information is used for authorization purposes. Further details regarding the authorization of the task message have been discussed in conjunction with FIGS. 6A and 6B. Subsequent to authorization, at step 508, message processor 204 extracts the task content and task instructions from the task message. The extracted task content and task instructions are then passed on to task manager 206. At step 206, the task is managed according to the task instruction and using the task content. In accordance with an embodiment of the invention, managing the task involves reading and/or writing operation on database 208. Managing the task may also include interacting with the task. The message may contain a series of instructions that could result in pre-programmed actions to be taken on the task based on the content of the message. The system can send a log of activity to the user, as well as send the results of the task to the owner. For example, in case the user books an airline ticket through a task message, the user can be emailed a copy of the confirmed ticket.

FIG. 6A and FIG. 6B are flowcharts representing the method to authorize a task message, in accordance with an embodiment of the invention. At step 602, task message is received by message receiver 202. The task message is then sent to message processor 204. After receiving the task message, message processor 204 extracts the content from the message, including the username and task, and sends an authorization request along with the username and task to task manager 206. At step 604, task manager 206 checks the user settings and determines if an authorization request needs to be sent. If the user settings state that an authorization request need not be sent, then step 606 is executed. At step 606, task manager 206 checks if the request is authorized according to the user settings. If the request is not authorized, step 608 is executed. At step 608, task manager 206 communicates to message processor 204 that the task message has been rejected. Message processor 204 sends the reject message to the user.

At step 606, if task manager 206 determines that the request is authorized, step 610 is preformed. At step 610 task manager 206 calls on the appropriate handler to execute the task. The appropriate handler performs read and/or write operation on database 208 to perform the task. At step 612, task manager 206 communicates the accomplishment of the task to message processor 204. Message processor 204 sends a message intimating the accomplishment of the task to the user.

At step 604, if task manager 206 determines that authorization request has to be sent to the user then step 614 is performed. At step 614, task manager 206 calls authorization manager 404 to store the task message as pending tasks. At step 616, task manager communicates the requirement of authorization to message processor 204, and message processor 204 sends out an authorization request to the user. Thereafter at step 618, an authorization request is received by message receiver 202. Message receiver 202 forwards the authorization request to message processor 204. Subsequently at step 620, Message processor 204 calls on task manager 206 to authorize the authorization message. Task Manager 206 responds to the message processor 204 with the authorization as well as the pending task message details for which the authorization message was sent. At step 622, message processor 204 checks whether the request has been authorized. If the authorization message approves the task, step 624 is performed. At step 624, the pending task is performed similar to step 610. At step 626, task manager 206 communicates the accomplishment of the task to message processor 204. Message processor 204 sends a message intimating the accomplishment of the task to the user.

At step 622, if the message processor determines that the authorization has failed, step 628 is performed. At step 628, the pending message is deleted from database 208. Then at step 630, task manager 206 communicates to message processor 204 that the task message has been rejected. Message processor 204 sends the reject message to the user.

The steps mentioned in the above methodology are exemplary and may be executed in a manner different than that described above. For example, instead of sending an authorization message, the user may log on to the system and authorize the task messages online. In an alternative embodiment of the invention, an application sits at the client end. The user can open the client and perform a task on the client, without worrying about connectivity with a server. The interface on the client can be a replica of the server application on which the task is to be finally performed. For the purpose of the user, she/he does not need to worry about executing the task online. The task can be performed in an offline mode. The application sitting on the client end synchronizes with the server as and when a connection can be established.

Hereinafter, exemplary cases about the implementation of the present invention are discussed. The examples have been provided merely for elucidating the understanding of the invention, and the description, in no way, limits the scope of the invention.

### EXAMPLE 1

### Photo Storage and Sharing

User Alfredo creates his account on a website Jambool.com. Jambool.com is a service provider that implements the current invention. The user logs on to his account with Jambool.com and creates a task for storing and sharing photos. An email address ‘Alfredo-photos@jambool.com’ is created and is provided to Alfredo. Alfredo also has an account with another photos storage and display site which does not implement the current invention. Alfredo faces difficulties while uploading photos on the photo storage and display site. He uses a browser to upload the photo files on the site. At times the connection to the site gets timed out and Alfredo has to start the entire uploading again. However, while using Jambool.com, Alfredo does not encounter any such problems. In order to upload the files, the user uses his email client to send an email containing the photo files to Alfredo-photos@jambool.com. The email client may be, for example, Microsoft Outlook™. Further, Alfredo's friend Christian also wants to upload photos on Alfredo's jambool.com photo display account. Christian attaches the photo files to an email and sends them to Alfredo-photos@jambool.com. Alfredo receives an email asking for authorization of Christian's email. Alfredo's replies to the email authorizing Christian's mail, and the photos sent by Christian are displayed on Alfredo's jambool.com photos page.

### EXAMPLE 2

### Data Back-Up and Retrieval

User Alfredo has user id ‘alfredo’ at Jambool. Jambool provides him with a task called ‘Data Backup’ that has an associated email address: alfredobackup@jambool.com. Whenever Alfredo wants to save some data on his computer that he doesn't want to lose (For example: Documents, photos and the like), he opens his favorite email client (e.g., AppleMail, Eudora, Outlook, some web based email), and composes an email to alfredobackup@jambool.com, and attaches the document he wants to backup. He clicks send button on his email client, and with that he is assured that the document is saved forever on Jambool. He gets an email from Jambool acknowledging the receipt of the document, and a list of some of the recent documents he had saved. A link for the task of data backup is also provided to user Alfredo. On clicking this link the browser opens a page from Jambool for this task. This page lists the recent file titles, and provides Alfredo with an index and a search box to find any particular file he may be looking for.

### EXAMPLE 3

### Blog Update

Jambool creates a task for Alfredo for blogging. Alfredo writes an email to alfredoblog@jambool.com to update his blog, using his favorite email application (web based email on Coldmail.com). He writes a small story about how frustrated he was with blogging sites, and this was an attempt to see if he could actually get it to work. Within a minute or so, Alfredo gets an email back from Jambool. The email tells him that his blog publish was successful, and gives him a link to his blog site. Alfredo clicks on the link—ttp://www.jambool.com/alfredo/blog—and his browser loads the page.

Hereinafter, the scalability of the invention is discussed.

The present invention has been designed to scale well for growth in the incoming volume as well as the growth in the number of users and tasks in the system. The following design considerations explain in more detail how this is done.

Task manager multiple instances: The services are designed such that there can be multiple instances of the task manager. The client, mail processor, chooses the service to send the request by querying a configuration class. There are two ways this service may be scaled: (a) On top of a single database there can be multiple instances of the same software accepting requests and processing them. The design of the service ensures that the servers are stateless, thus making it possible for different servers to handle different parts of the same request workflow; (b) One of the arguments that the client provides when determining the service address is the user id. User id can partition the service and the database by users in order to scale the data store.

Message size and content: The present invention intends to limit the case of large sized email addresses. The extractors will be responsible for taking out larger pieces of content—such as attachments—and storing them remotely with a different service. These attachments are never passed to the task manager. The extractor would replace the attachment in the original email with the address of the remotely stored object. For this reason, the extractors are invoked even if the message is to be kept as ‘pending authorization.’

Incoming mail servers: It is possible for the system of the invention to have multiple instances of the mail servers and mail processors running, and sending content to the task manager. The mail servers do not rely on any common database or service except for the mail content handling service (MACH), and thus they can have multiple instances without blocking each other.

Hereinafter, the extensibility of the Handlers and Extractors is discussed.

The present invention also allows new features to be added to the application easily. Several different kinds of applications can be built using this platform. The architecture of the present invention will enable the creation of a very diverse set of applications using email as the transport.

Blog publishing: The present invention can be extended to build a blog publishing mechanism for users. Users will get an email address for publishing blogs, e.g., userblog@jambool.com. An extractor, say Text_Extractor, will extract the message text. This text will be a part of the content hash that arrives at the task manager. Task manager will invoke a handler, called Blog_Publish_Handler, and it will update the user's blog with the message text.

Photo/Video Album creation and publishing: Each task can have its own photo and video album. In order to publish them, the users can simply attach them to an email and send it to their task. An extractor, say File_Extractor, will extract these files and store them in a file server. It would place the address of the file in the email and the content hash. On the Task Manager, a Multimedia_Content_Handler will pick these addresses and add them to the task. From then on, the photos and video in the email will be accessible to the user from her/his tasks on the website.

Programmable Tasks: Handlers can be interpreters that interpret the programs written in the email message. Thus users can send programs in their email messages to their tasks and the Task Manager handler will pick them from the content hash and execute them—and these could be placed in the content hash as just text content or program content by an extractor.

Executing remote queries: Handlers may be implemented for answering users' queries about their tasks and content. As an example, the users can remotely search and get back content by email. In order to do so, users can send a request, say “find my_grad_School_application.doc”. Query_Handler will look at the content and if it matches its query grammar, it executes the query and emails the user any matching results and content.

Address Book: Users can build address book by sending emails to their tasks. An Address_Extractor in the mail processor will extract all content that look like addresses and store them in the content hash. On the Task Manager, an Address_Book_Handler will pick it out of the hash and store it in the user's address book. Users can then access their address book online.

Calendar Management: This platform can be used to manage appointments and calendars. Users can send their appointments by email to their tasks, and an extractor, say Appointment_Extractor, will place the appointments in the content hash. On the MACH, a handler, say Calendar_Handler, will place these events in the user's calendar.

Hereinafter, a system implementation of the invention is discussed.

The system, as described in the current invention or any of its components, may be embodied in the form of a processing machine. Typical examples of a processing machine include a computer, a programmed microprocessor, an integrated circuit, and other devices or arrangements of devices that are capable of implementing the steps of the method of the current invention.

The processing machine executes a set of instructions that are stored in one or more storage elements, in order to process input data. The storage elements may also hold data or other information as desired. The storage element may be in the form of an information destination or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for managing an online task through a task message, the task message being sent by a remote user, the method comprising:
a) receiving the task message;
b) extracting task content from the task message;
c) determining an activity to be performed on the task;
d) managing the online task based on the activity and the task content.

2. The method as recited in claim 1 further comprising the step of creating an addressable entity, the addressable entity receiving the task message.

3. The method as recited in claim 2 wherein the addressable entity is specific to the task.

4. The method as recited in claim 1 wherein the activity is determined from the task message.

5. The method as recited in claim 1 wherein the task message further comprises task information.

6. The method as recited in claim 1 further comprising the step of determining the task that needs to be managed based on the task information.

7. The method as recited in claim 1 further comprising the step of authorizing the task message.

8. The method as recited in claim 7 wherein the step of authorizing the task comprises the steps of:
a) sending an authorization request to an owner of the task;
b) receiving a response to the authorization request.

9. The method as recited in claim 7 further comprising the step of obtaining authorization preferences.

10. The method as recited in claim 7 wherein the task message is a program.

11. The method as recited in claim 1 further comprising the step of sending the results of the managed task to at least one recipient.

12. A system for managing an online task through a task message, the task message being sent by a remote user, the system comprising:
a) a message receiver for receiving the task message;
b) a message processor for extracting task content from the task message;
c) a task manager for managing the online task based on the task content; and
d) a database interfacing with the task manager.

13. The system as recited in claim 12 wherein the task manager further comprises at least one handler for writing the task content on the database.

14. The system as recited in claim 12 further comprising means for determining the task that needs to be performed.

15. The system as recited in claim 12 further comprising means for creating an addressable entity.

16. The system as recited in claim 12 wherein the message receiver comprises a Message Transfer Agent (MTA).

17. The system as recited in claim 12 further comprising means for authorizing the task message.

18. The system as recited in claim 17 further comprising:
a) means for sending an authorization request to an owner of the task; and
b) means for receiving a response to the authorization request.

19. A computer program product for use with a computer, the computer program product comprising a computer usable medium having a computer readable program code embodied therein for managing an online task through a task message, the task message being sent by a remote user, the method comprising the steps of:
a) receiving the task message;
b) extracting the sender information and the task content from the task message; and
c) managing the online task using the task content.

20. The computer program product as recited in claim 19 further comprising the step of creating an addressable entity, the addressable entity receiving the task message.

21. The computer program product as recited in claim 20 wherein the addressable entity is specific to the task.

22. The computer program product as recited in claim 19 further comprising the step of determining the task that needs to be performed.

23. The computer program product as recited in claim 19 further comprising the step of authorizing the task message.

24. The computer program product as recited in claim 19 further comprising the step of sending the results of the managed task to at least one recipient.

25. A method for managing an online task through a task message, the task message being addressed to an addressable entity, the addressable entity being specific to the online task, the task message comprising sender information and task content, the task message being sent by a remote user, the method comprising the steps of:
a. receiving the task message addressed to the addressable entity;
b. extracting the sender information and the task content from the task message;
c. determining an activity to be performed on the task;
d. sending an authorization request to an owner of the task; and
e. in case of successful authorization, managing the online task based on the activity and the task content.
